(19) United States
(12) Patent Application Publication
(10) Pub. No.: US 2007/0121597 A1
(43) Pub. Date: May 31, 2007

(54) Apparatus and method for processing VoIP packet having multiple frames

(76) Inventors: Eung-Don Lee, Daejon (KR); O-Hyung Kwon, Daejon (KR); Soo-In Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 11/520,882

(22) Filed: Sep. 14, 2006

(30) Foreign Application Priority Data
Sep. 12, 2005 (KR) 10-2005-0121163

(51) Int. Cl. H04L 12/66

(52) U.S. Cl. 370/356

(57) ABSTRACT

Provided is an apparatus and method for processing a Voice over Internet Protocol (VoIP) packet with multiple frames. The apparatus includes: a transmission packet processing unit for receiving a frame from a speech codec, forming a Real-time Transport Protocol (RTP) payload in a form of multiple frames and transmitting the RTP payload to an RTP stack; and a reception packet processing unit for receiving an RTP packet from the RTP stack, storing the RTP packet in a jitter buffer, performing dejittering, separating frames from the RTP payload one by one and transmitting the frames to the speech codec.

### FIELD OF THE INVENTION

The present invention relates to an apparatus and method for processing a Voice over Internet Protocol (VoIP) packet having multiple frames; and, more particularly, to an apparatus and method for processing VoIP packets having multiple frames which can form a structure where a VoIP packet includes a plurality of frames to reduce load onto a network in a VoIP communication system, process the VoIP packet having the multiple frames, and prevent deterioration of speech quality by detecting and exactly distinguishing packet loss from a speech silence section.

### DESCRIPTION OF RELATED ART

It is possible to reduce load of Real-time Transport Protocol (RTP), User Datagram Protocol (UDP), and an Internet Protocol (IP) header applied onto a network by transmitting a plurality of frames in a Voice over Internet Protocol (VoIP) packet in a VoIP terminal or gateway.

When multiple frames are simultaneously transmitted, speech quality might be deteriorated due to increase of delay in speech codec. Accordingly, speech delay is set to be shorter than a maximum of 210 ms in the VoIP terminal or gateway.

FIG. 1 is a table showing frame intervals of a general speech codecs and transmission intervals of the VoIP packets.

The frame interval and the VoIP packet transmission interval show that a maximum of 7 to 20 frames can be simultaneously transmitted in a VoIP packet.

A discontinuous transmission (DTX) method may be used to reduce the load of the network in the VoIP terminal or the gateway. According to the DTX, the VoIP packet is transmitted only in an active speech section based on voice activity detection (VAD)/comfort noise generation (CNG) functions of the speech codec, but the VoIP packet is not transmitted in a silence section.

FIG. 2 shows a general speech stream.

In the speech stream, a speech frame 210 is transmitted at active speech section. A silence descriptor (SID) frame 220 having noise information is transmitted in the silence section only when noise characteristics are changed. Otherwise, data are not transmitted in non-transmission sections 230 and 240.

FIG. 3 is a table showing speech frame lengths and silence descriptor (SID) frame lengths of general speech codecs.

When the above-mentioned two methods are used to reduce the load onto the network, a compatibility problem occurs between VoIP terminals or gateways manufactured by different manufacturers.

Although the same speech codecs are used for the VoIP terminal or the gateway, voice activity detection (VAD) function may or may not be provided according to a manufacturing company. When the VAD function is provided, a method for forming multiple frames may be different according to the manufacturing company.

Meanwhile, KR Patent No. 10-0372289 (reference 1) filed by LG Electronics Inc. on Dec. 20, 2000 and granted on Feb. 3, 2003, discloses a method for transmitting/receiving a plurality of speech channel data included in one packet in a VoIP communication system. According to the cited reference 1, when speech communication is performed between VoIP gateways based on real-time transport protocol (RTP) on Local Area Network (LAN) and Wide Area Network (WAN), a User Datagram Protocol (UDP) packet carries speech RTP packets of diverse channels in transmission/reception. Accordingly, when diverse speech channels communicate between gateways, an Ethernet header, an IP header, and a user datagram protocol (UDP) header which are attached to each channel are reduced into one, and thus IP data traffic can be reduced on network.

The reference 1 is not a method for transmitting/receiving an RTP packet of a channel loaded with frames, but a method for transmitting/receiving a UDP packet loaded with the speech RTP packets of diverse channels, there is a limitation that a method of the reference 1 can be applied only to a transmission between gateways. Also, there is another problem that the load of the RTP header is not reduced on the network. Although the method has a problem that the speech quality of multiple channels can be simultaneously deteriorated, it does not provide a dejittering method for solving the problem.

### SUMMARY OF THE INVENTION

It is, therefore, an object of the present invention to provide an apparatus and method for processing a Voice over Internet Protocol (VoIP) packet loaded with multiple frames which can form a structure where a VoIP packet includes a plurality of frames to reduce load onto a network in a VoIP communication system, process a VoIP packet having multiple frames and prevent deterioration of speech quality by detecting and exactly distinguishing packet loss from a speech silence section.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a apparatus for processing a VoIP packet loaded with multiple frames, the apparatus including: a transmission packet processing unit for receiving frames from a speech codec, forming a Real-time Transport Protocol (RTP) payload including multiple frames and transmitting the RTP payload to an RTP stack; and a reception packet processing unit for receiving the RTP packet from the RTP stack, storing the RTP packet in a jitter buffer, performing dejittering, separating frames from the RTP payload one by one and transmitting the frames to the speech codec.

In accordance with another aspect of the present invention, there is provided a method for processing a Voice over Internet Protocol (VoIP) packet loaded with multiple frames, the method including the steps of: a) setting up the number of frames for each packet by a user to form an RTP packet including multiple frames in a transmission packet processing unit, and initializing a sequence number and a timestamp to be used in the RTP stack, and a frame counter for displaying the number of frames inserted into one RTP payload; b) receiving a frame and information of the frame which will be referred to as frame information from a speech codec and checking a type of the frame; c) when the type of the frame is a non-transmission frame type, increasing the timestamp as many as frames and going to the frame counter initializing process of the step a); d) when the type of the frame is a speech frame type, processing the speech frame and outputting the RTP payload, the timestamp and the sequence number to the RTP stack; and e) when the type of the frame is a silence descriptor (SID) frame type, inserting the SID frame into the RTP payload, increasing the timestamp as many as the frames, outputting the RTP payload, the timestamp and the sequence number to the RTP stack, and increasing one sequence number to create a next RTP payload.

In accordance with another aspect of the present invention, there is provided a method for processing a VoIP packet loaded with multiple frames, the method including the steps of: a) receiving a speech frame length, and a SID frame length for each speech codec, speech codec information obtained from a codec negotiation after a call process, and speech codec transmission rate information, and receiving the RTP packet from an RTP stack and storing an RTP payload and a timestamp in a jitter buffer to separate the multiple frames from an RTP packet in the reception packet processing unit; b) storing a timestamp of the first RTP payload stored in the jitter buffer in a pre-defined timestamp register and initializing a timer; c) comparing an RTP payload length with a speech frame length; d) when the RTP payload length is longer than the speech frame length, separating data as much as the speech frame length from the RTP payload, outputting the speech frame and the frame information, i.e., speech, to the speech codec, storing the frame information in the pre-defined frame type register, increasing a timestamp register value as many as frames, and correcting the timestamp of a current RTP payload into the timestamp register value; e) when the RTP payload length is the same as the speech frame length, separating data as much as the speech frame length from the RTP payload, outputting the speech frame and the frame information to the speech codec, storing the frame information in the frame type register, increasing the timestamp register value as many as frames and removing a current RTP payload from the jitter buffer; f) when the RTP payload length is shorter than the speech frame length, separating data as much as SID frame length from the RTP payload, outputting the SID frame and the frame information, i.e., SID, to the speech codec, storing the frame information in the frame type register, increasing the timestamp register value as many as frames and removing a current RTP payload from the jitter buffer; g) waiting for an operation of the timer after the steps d) to f), when the timer is increased as many as frames, and checking whether there is an RTP payload having a timestamp the same as the timestamp register value in the jitter buffer when interrupt occurs; h) when there is an RTP payload having the same timestamp as the timestamp register value, going to the step c), and when there is no RTP payload having the timestamp the same as the timestamp register value, checking the frame type register, determining there is a packet loss when a former frame type is the speech frame, notifying the packet loss to the speech codec, performing a packet loss concealment (PLC) process in the speech codec; or when the former frame type is the SID frame, determining that the frame is in a non-transmission section, notifying the frame information of the non-transmission section to the speech codec, and performing a comfort noise generation (CNG) process in the speech codec; and i) increasing the timestamp register value as many as frames and going to the step g).

### BRIEF DESCRIPTION OF THE DRAWINGS

The above and other objects and features of the present invention will become apparent from the following description of the preferred embodiments given in conjunction with the accompanying drawings, in which:

FIG. 1 is a table showing frame intervals of general speech codecs and transmission intervals of Voice over Internet Protocol (VoIP) packets;

FIG. 2 shows a general speech stream;

FIG. 3 is a table illustrating a length of each speech frame of a general speech codec and a length of a silence descriptor (SID) frame;

FIG. 4 shows a formation of a VoIP packet with general multiple frames;

FIG. 5 is a block diagram showing an apparatus for processing the VoIP packet with the multiple frames in accordance with the embodiment of the present invention;

FIG. 6 is a flowchart describing a method for processing the VoIP packet with the multiple frames in accordance with an embodiment of the present invention; and

FIG. 7 is a flowchart describing the method for processing the VoIP packet with the multiple frames in accordance with the embodiment of the present invention.

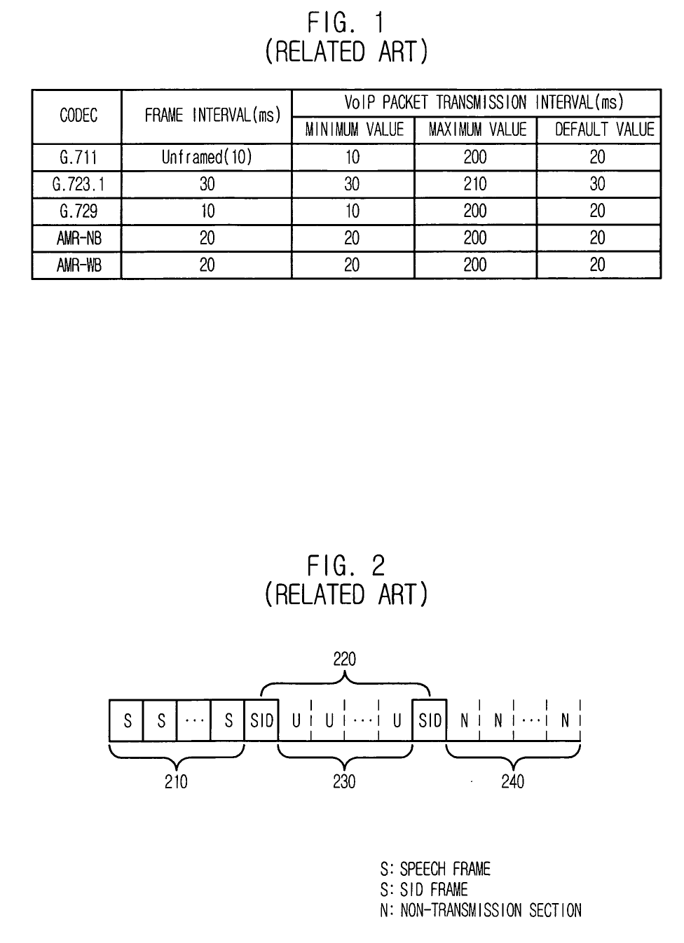

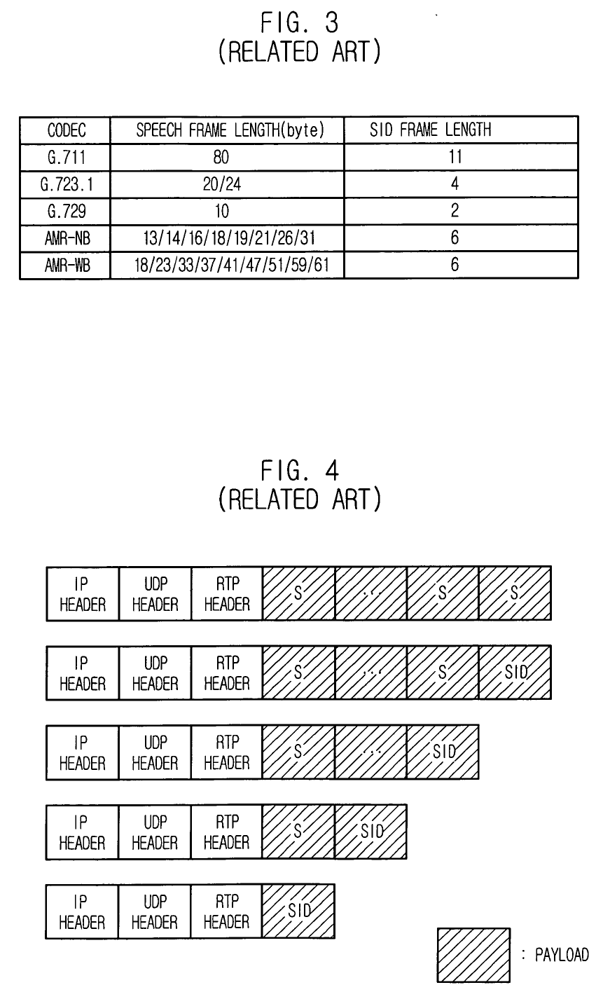

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

FIG. 4 shows general Voice over Internet Protocol (VoIP) packets having multiple frames.

Traffic of a network can be reduced by transmitting a plurality of frames loaded in one VoIP packet and thereby reducing a load of Real-time Transport Protocol (RTP) header, a User Datagram Protocol (UDP) header, and an Internet Protocol (IP) header into one in a Voice over Internet Protocol (VoIP) terminal or a gateway. Also, load of unnecessary silence can be removed by using a Discontinuous Transmission (DTX) method that VoIP packets are transmitted only in an active speech section based on a voice activity detection (VAD) function and a comfort noise generation (CNG) function of a speech codec, but VoIP packets are not transmitted in a silence section.

When a method for transmitting the VoIP packet loaded with multiple frames and the DTX method are used together, the VoIP packets can be formed as shown in FIG. 4. That is, when a silence descriptor (SID) frame comes out, or a packet is completely filled up with frames while inserting speech frames corresponding to an active speech section into an RTP payload one by one, one VoIP packet is created.

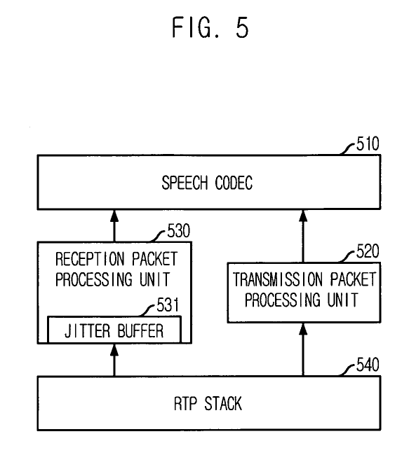

FIG. 5 is a block diagram showing an apparatus for processing VoIP packets having the multiple frames in accordance with an embodiment of the present invention.

The VoIP packet process apparatus of the present invention includes a transmission packet processing unit 520 and a reception packet processing unit 530.

The transmission packet processing unit 520 receives frames from a speech codec 510, forms an RTP payload loaded with multiple frames and transmits the complete RTP payload to an RTP stack 540.

The reception packet processing unit 530 receives the RTP packet from the RTP stack 540, stores the RTP packet in a jitter buffer 531, performs dejittering, separates frames from the RTP payload one by one, and transmits the frames to the speech codec 510.

The transmission packet processing unit 520 receives the frame and frame information, e.g., speech, SID, and non-transmission, from the speech codec 510, forms an RTP payload including multiple frames and transmits the RTP payload, a timestamp and a sequence number to the RTP stack 540.

The reception packet processing unit 530 receives the RTP packet from the RTP stack 540, stores the RTP packet in the jitter buffer 531, separates frames from the RTP payload one by one and transmits the frames and the frame information, e.g., speech and SID, to the speech codec 510.

The jitter buffer 531 detects packet loss or a non-transmission section based on the timestamp and the frame information, and transmits the result to the speech codec 510.

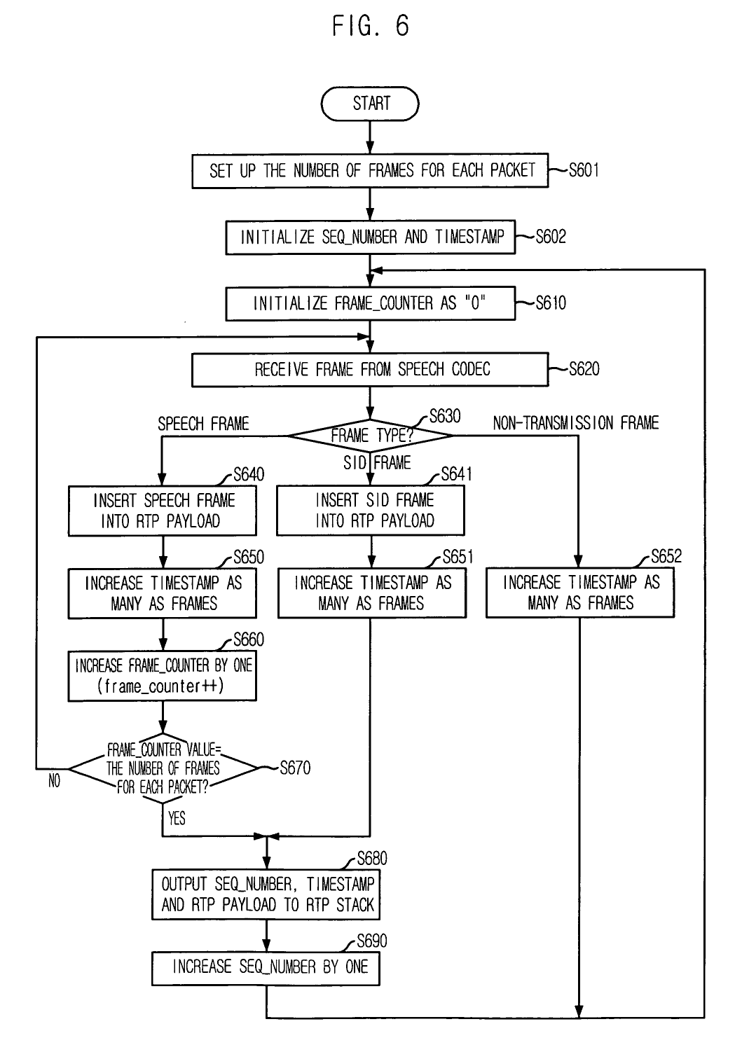

FIG. 6 is a flowchart describing a method for processing VoIP packets having multiple frames in accordance with an embodiment of the present invention, and it shows a process for forming the RTP packet loaded with multiple frames.

At step S601, the number of frames for each packet is set up by a user. At step S602, under assumption that a call process ends between the VoIP terminals or between the gateways, and a speech channel opens, the transmission packet processing unit initializes a sequence number (seq_number) and a timestamp to be used in the RTP stack.

At step S610, a frame counter (frame_counter) displaying the number of frames inserted into one RTP payload is initialized to “0”. The transmission packet processing unit waits for the input of the frame and the frame information from the speech codec, e.g., speech, SID, non-transmission information.

When one frame and its frame information are inputted from the speech codec at step S620, a frame type is checked at step S630.

When it turns out that the frame type is a non-transmission frame type, the timestamp is increased as many as frames at step S652. A logic flow goes to the step S610 of initializing the frame counter to process the next frame and subsequent process is repeated.

When it turns out that the frame type is a speech frame at the step S630, the speech frame is inserted into the RTP payload at step S640, and the timestamp is increased as many as the frames at step S650. Subsequently, the number of the frame counter is increased by one at step S660.

At step S670, it is checked whether the number of the frame counter is the same as the number of frames for each packet. When the number of the frame counter is the same as the number of frames for each packet, it is determined that the number of frames to be inserted into the RTP payload is filled up with frames. Accordingly, the RTP payload, the timestamp and the sequence number are outputted to the RTP stack at step S680, and one sequence number is increased to create a next RTP payload at step S690. When the frame counter is not the same as the number of frames for each packet, the logic flow goes to the step S620 of receiving a frame from the speech codec.

When it is turned out that the frame type is the SID frame at the step S630, the SID frame is inserted into the RTP payload at step S641, and the timestamp is increased as many as the frames at step S651. Subsequently, just as a case that the frame type is a speech frame, the RTP payload, the timestamp and the sequence number are outputted to the RTP stack at step S680, and one sequence number is increased to create a next RTP payload at step S690.

When one RTP packet is created by the above method, the frame is inputted from the speech codec and the above process is repeated.

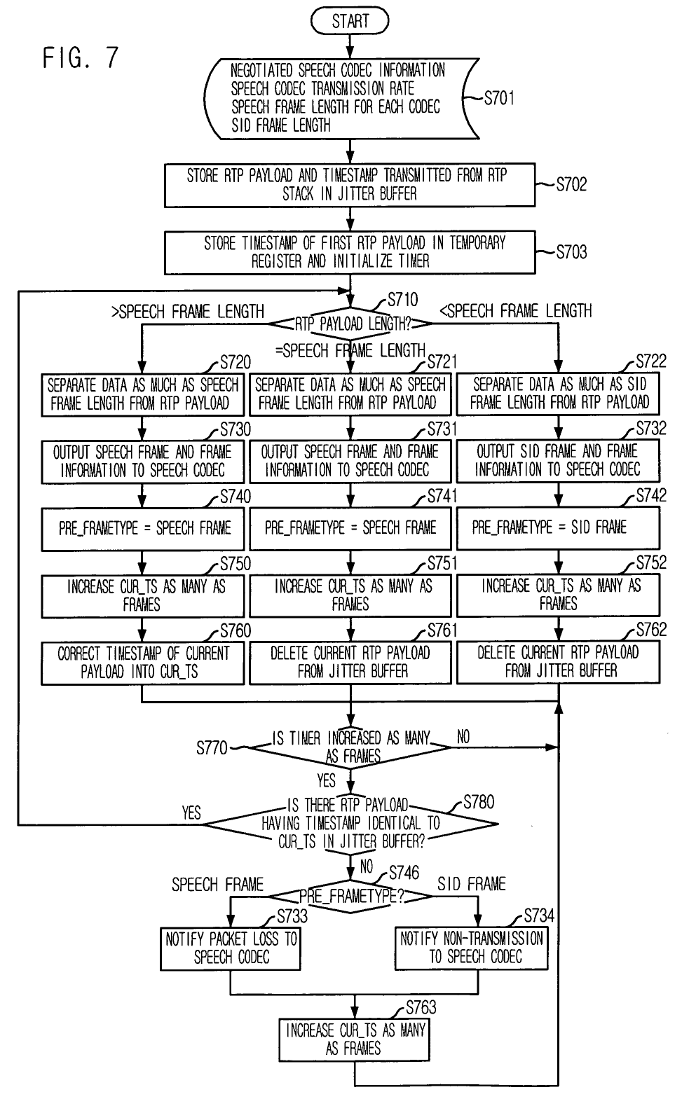

FIG. 7 is a flowchart describing a method for processing VoIP packets having multiple frames in accordance with another embodiment of the present invention. It shows a process for separating the multiple frames from the RTP packet in the reception packet processing unit.

At step S701, it is assumed that a speech frame length for each speech codec and a SID frame length are stored in a memory, and speech codec information obtained from codec negotiation after a call process is inputted from a call process protocol such as H.323 or session initiation protocol (SIP). The speech codec such as G.723.1, adaptive multi-rate narrow band (AMR-NB), and adaptive multi-rate wideband (AMR-WB) has a plurality of codec transmission rates and the length of speech frames is different according to the codec transmission rate. Accordingly, it is also assumed at step S701 that a codec transmission rate can be detected in the speech codec having a plurality of codec transmission rates after the call process. A header displaying a transmission rate is added to a frame in the codec with diverse codec transmission rates such as G.723.1, AMR-NB and AMR-WB. Accordingly, when the frame is received, it is possible to easily detect transmission rate information of each codec by checking the header of the frame. In general, a call process protocol such as H.323 and SIP includes a sampling rate of the codec in codec information, but it does not include a transmission rate of the codec. Therefore, when the reception packet processing unit does not detect the transmission rate information for each codec, a protocol standard should be modified to include the transmission rate of the codec in the codec information of the call process protocol such as H.323 or the SIP.

When the reception packet processing unit receives an RTP packet from the RTP stack, an RTP payload and a timestamp are stored in a jitter buffer at step S702.

At step S703, the timestamp of the first RTP payload stored in the jitter buffer is stored in a temporary register defined as “cur_ts” and a timer is initialized.

At step S710, an RTP payload length is compared with a speech frame length, and a following process is performed based on the comparison result.

When the RTP payload length is longer than the speech frame length, it means that the RTP payload includes at least one speech frame. Therefore, data are separated as much as the speech frame length from the RTP payload at step S720, and a speech frame and speech frame information are outputted to the speech codec at step S730.

At step S740, the corresponding frame information, i.e., speech, is stored in the temporary register defined as “pre_frametype” to separate packet loss from a non-transmission section in silence.

At step S750, the register value “cur_ts” is increased as many as the frames for dejittering and the timestamp of a current RTP payload is corrected into the register value “cur_ts” at step S760. This is because dejittering should be performed on each frame to process the frames in the non-transmission section whereas the timestamp of the RTP packet increases with respect to multiple frames.

When the RTP payload length is the same as the speech frame length at step S710, it means that only one speech frame exists in the RTP payload. At step S721, data are separated as much as the speech frame length from the RTP payload, just as the case that the RTP payload length is longer than the speech frame length. At step S731, the speech frame and the frame information, i.e., the speech, are outputted to the speech codec. At step S741, the frame information is stored in a “pre_frametype” register. At step S751, the “cur_ts” register value is increased as many as frames. When the data are separated as much as the speech frame length from the RTP payload, there are no data left in the RTP payload. Accordingly, a current RTP payload is removed from the jitter buffer at step S765.

When it turns out at step S710 that the RTP payload length is shorter than the speech frame length, only one SID frame exists in the RTP payload. Accordingly, data are separated as much as the SID frame length from the RTP payload at step S722, and the SID frame and the corresponding frame information are outputted to the speech codec at step S732. The frame information is stored in a “pre_frametype” register at step S742, and the “cur_ts” register value is increased as many as frames at step S752.

Just as the case that the RTP payload length is the same as the speech frame length, when the data are separated as much as the SID frame length from the RTP payload, the data do not exist in the RTP payload. Accordingly, the current RTP payload is deleted in the jitter buffer at step S766.

After the process of separating one frame from the RTP payload is completed, it is checked at step S770 whether the timer is increased as many as frames. When interrupt occurs, it is checked at step S780 whether there is an RTP payload having a timestamp the same as a “cur_ts” register value in the jitter buffer. When all frames are separated from the RTP payload, a new RTP payload becomes an object for search. Otherwise, a currently processed RTP payload becomes an object for search by the step S760 of correcting the timestamp of the current RTP payload into the “cur_ts” register value. When all frames are separated and there is no RTP payload having the timestamp the same as the “cur_ts” register value in the jitter buffer, it is considered as packet loss or a non-transmission section in silence.

As shown in the formation of the speech stream of FIG. 2, the SID frame is transmitted before the non-transmission section is generated based on characteristics of the speech stream. Therefore, when there is no RTP payload having the timestamp the same as the “cur_ts” register value in the jitter buffer, the “pre_frametype” register is checked at step S746. When a former frame type is the speech frame, it is considered as the packet loss. Subsequently, the packet loss is notified to the speech codec at step S733 and a process of packet loss concealment (PLC) is performed in the speech codec. When the former frame type is the SID frame, it is considered as the non-transmission section. Subsequently, the frame information of the non-transmission section is notified to the speech codec at step S734 and a process of comfort noise generation (CNG) is performed in the speech codec.

Since dejittering is performed on a frame basis, the “cur_ts” register value is increased as many as frames at step S753 and a process of waiting until a time when the timer interrupt occurs is repeated.

In the present invention, the method for transmitting/receiving the VoIP packet loaded with the multiple frames is not limited only to the data transmission between VoIP terminals, but it can be applied to all data transmission between VoIP terminals, between VoIP gateways and between the VoIP terminal and the gateway.

The present invention can secure compatibility between VoIP terminals or gateways produced by different manufacturers by forming one VoIP packet loaded with multiple frames and transmitting/receiving the VoIP packet including a plurality of frames in the VoIP communication system.

Also, the present invention can prevent the speech quality from deterioration by providing the dejittering method which can exactly detect and distinguish the packet loss and the non-transmission section in the speech silence.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0121163, filed with the Korean Intellectual Property Office on Dec. 9, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for processing a Voice over Internet Protocol (VoIP) packet loaded with multiple frames, comprising:
a transmission packet processing means for receiving a frames from a speech codec, forming a Real-time Transport Protocol (RTP) payload including multiple frames and transmitting the RTP payload to an RTP stack; and
a reception packet processing means for receiving the RTP packet from the RTP stack, storing the RTP packet in a jitter buffer, performing dejittering, separating frames from the RTP payload one by one and transmitting the frames to the speech codec.

2. The apparatus as recited in claim 1, wherein the transmission packet processing means receives the frame and speech/silence descriptor (SID)/non-transmission information of the frame, which is referred to frame information, from the speech codec, forms an RTP payload loaded with multiple frames and transmits the RTP payload, a timestamp and a sequence number to the RTP stack.

3. The apparatus as recited in claim 1, wherein the reception packet processing means receives the RTP packet from the RTP stack, stores the RTP packet in the jitter buffer, separates frames from the RTP payload one by one, and transmits the frames and the frame information.

4. The apparatus as recited in claim 1, wherein the jitter buffer detects packet loss or a non-transmission section based on the timestamp and the frame information, and transmits the detected information to the speech codec.

5. A method for processing a Voice over Internet Protocol (VoIP) packet loaded with multiple frames, comprising the steps of:
a) setting up the number of frames for each packet by a user to form a Real-time Transport Protocol (RTP) packet including multiple frames in a transmission packet processing unit, and initializing a sequence number and a timestamp to be used in the RTP stack, and a frame counter for displaying the number of frames inserted into one RTP payload;
b) receiving a frame and information of the frame which will be referred to as frame information from a speech codec and checking a type of the frame;
c) when the type of the frame is a non-transmission frame type, increasing the timestamp as many as frames and going to the frame counter initializing process of the step a);
d) when the type of the frame is a speech frame type, processing the speech frame and outputting the RTP payload, the timestamp and the sequence number to the RTP stack; and
e) when the type of the frame is a silence descriptor (SID) frame type, inserting the SID frame into the RTP payload, increasing the timestamp as many as frames, outputting the RTP payload, the timestamp and the sequence number to the RTP stack, and increasing one sequence number to create a next RTP payload.

6. The method as recited in claim 5, wherein in the step a), when a call process ends between VoIP terminals or gateways and a speech channel opens, the transmission packet processing unit initializes the sequence number and the timestamp used in the RTP stack, initializes the frame counter displaying the number of frames inserted into one RTP payload as “0”, and waits until the frame and speech/SID/non-transmission information of the frame are received from the speech codec to form the RTP packet including multiple frames in the transmission packet processing unit.

7. The method as recited in claim 5, wherein the step d) includes:
d1) inserting the speech frame into the RTP payload, increasing the timestamp as many as frames including the inserted frame and increasing a value of the frame counter by one;
d2) checking whether the value of the frame counter is the same as the number of frames for each packet;
d3) when the frame counter is the same as the number of frames for each packet and the RTP payload is filled up with frames, outputting the RTP payload, the timestamp and the sequence number to the RTP stack and increasing the sequence number by one to create a next RTP payload; and
d4) when the frame counter is not the same as the number of frames for each packet, going to the process of receiving a frame from the speech codec of the step b).

8. A method for processing a Voice over Internet Protocol (VoIP) packet loaded with multiple frames, comprising the steps of:
a) receiving a speech frame length, and a silence descriptor (SID) frame length for each speech codec, speech codec information obtained from a codec negotiation after a call process, and speech codec transmission rate information, and receiving the RTP packet from an RTP stack and storing an RTP payload and a timestamp in a jitter buffer to separate the multiple frames from a Real-time Transport Protocol (RTP) packet in the reception packet processing unit;
b) storing a timestamp of the first RTP payload stored in the jitter buffer in a pre-defined timestamp register and initializing a timer;
c) comparing an RTP payload length with a speech frame length;
d) when the RTP payload length is longer than the speech frame length, separating data as much as the speech frame length from the RTP payload, outputting the speech frame and the frame information, i.e., speech, to the speech codec, storing the frame information in the pre-defined frame type register, increasing a timestamp register value as many as frames, and correcting the timestamp of a current RTP payload into the timestamp register value;
e) when the RTP payload length is the same as the speech frame length, separating data as much as the speech frame length from the RTP payload, outputting the speech frame and the frame information to the speech codec, storing the frame information in the frame type register, increasing the timestamp register value as many as frames and removing a current RTP payload from the jitter buffer;
f) when the RTP payload length is shorter than the speech frame length, separating data as much as SID frame length from the RTP payload, outputting the SID frame and the frame information, i.e., SID, to the speech codec, storing the frame information in the frame type register, increasing the timestamp register value as many as frames and removing a current RTP payload in the jitter buffer;
g) waiting for an operation of the timer after the steps d) to f), checking that the timer is increased as many as frames, and checking whether there is an RTP payload having a same timestamp as the timestamp register value in the jitter buffer when interrupt occurs;
h) when there is an RTP payload having the same timestamp as the timestamp register value, going to the step c), and when there is no RTP payload having the same timestamp as the timestamp register value, checking the frame type register, determining there is a packet loss when a former frame type is the speech frame, notifying the packet loss to the speech codec, performing a packet loss concealment (PLC) process in the speech codec; or when the former frame type is the SID frame, determining that the frame is in a non-transmission section, notifying the frame information of the non-transmission section to the speech codec, and performing a comfort noise generation (CNG) process in the speech codec; and
i) increasing the timestamp register value as many as frames and going to the step g).
